(19) United States
(12) Patent Application Publication
(10) Pub. No.: US 2023/0145205 A1
(43) Pub. Date: May 11, 2023

(54) POWER FEED MANAGEMENT SYSTEM, POWER FEED MANAGEMENT APPARATUS, AND INFORMATION DISPLAY APPARATUS

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Katsuya KOBAYASHI, Okazaki-shi (JP); Takahiro HIRANO, Gotemba-shi (JP); Midori SUGIYAMA, Susono-shi (JP); Ryunosuke YAMASHITA, Susono-shi (JP)

(21) Appl. No.: 18/053,754

(22) Filed: Nov. 9, 2022

(30) Foreign Application Priority Data
Nov. 11, 2021 (JP) 2021-184050

(51) Int. Cl. B60L 53/67; H02J 50/12; H02J 50/40; H02J 50/90; H02J 50/80; H02J 7/00; B60L 53/62

(52) U.S. Cl. CPC B60L 53/67; H02J 50/12; H02J 50/402; H02J 50/90; H02J 50/80; H02J 7/0047; B60L 53/62

(57) ABSTRACT

A management server performs processing including updating map information with change of a placement location of a power feed mat corresponding to a power feed control device being determined as not being required (S204) when the management server determines that it has received power feed information from the power feed control device (YES in S200) and when the management server determines an integrated value of an amount of power feed as being equal to or larger than a threshold value (YES in S202), updating the map information with change of the placement location of the power feed mat corresponding to the power feed control device being determined as being required (S206) when the management server determines the integrated value of the amount of power feed as being smaller than the threshold value (NO in S202), and notifying a terminal (S208).

This nonprovisional application is based on Japanese Patent Application No. 2021-184050 filed with the Japan Patent Office on Nov. 11, 2021, the entire contents of which are hereby incorporated by reference.

### BACKGROUND

### Field

The present disclosure relates to management of a plurality of power feed mats.

### Description of the Background Art

For example, Japanese Patent Laying-Open No. 2018-157686 discloses a technique to stop or suppress, when a vehicle senses presence of a foreign matter on a road in front of a vehicle body while the vehicle travels on a power feed lane where a plurality of power feed units are provided along a travel lane, power feed from power feed units present within a prescribed range in front and in the rear of a point where presence of the foreign matter is sensed.

In addition to a construction in which a position of a power feed unit is fixed by burial of the power feed unit in a road as described above, a construction in which a movable power feed mat can be placed at any position has been known.

### SUMMARY

When power feed mats as described above are placed at a plurality of locations, a plurality of electrically powered vehicles that can use the power feed mats use power feed mats on a travel path or closest power feed mats. Consequently, the number of visiting electrically powered vehicles may be imbalanced among the plurality of power feed mats. Since the power feed mats are constructed to be movable, in order to suppress the imbalance as described above also after placement, it is required to specify whether or not a placement position of each of the plurality of power feed mats is appropriate.

An object of the present disclosure is to provide a power feed management system, a power feed management apparatus, and an information display apparatus that can specify whether or not a placement position of each of a plurality of power feed mats is appropriate.

A power feed management system according to one aspect of the present disclosure includes a plurality of power feed mats and a management apparatus that manages a power feed state of each of the plurality of power feed mats. The power feed mat generates power feed information on an amount of power feed to a power feed target and transmits the power feed information to the management apparatus. The management apparatus specifies a first power feed mat smaller in amount of power feed than other power feed mats among the plurality of power feed mats, based on the power feed information received from each of the plurality of power feed mats.

Thus, a power feed mat lower in utilization efficiency than other power feed mats can be specified based on the power feed state of the plurality of power feed mats.

In one embodiment, the management apparatus obtains position information of the power feed target that moves in a predetermined region provided with the plurality of power feed mats and a charging state of a power storage mounted on the power feed target. The management apparatus specifies a placement position where an amount of power feed larger than an amount of power feed at a placement position of the first power feed mat is expected, based on the position information and the charging state that have been obtained.

Thus, since a placement position expected to be larger in amount of power feed than the placement position of the first power feed mat is specified, utilization efficiency of the first power feed mat can be made higher by changing the placement position of the first power feed mat to the specified placement position.

Furthermore, in one embodiment, the power feed management system further includes a notification apparatus that gives information about the first power feed mat.

Thus, the user can recognize information on the first power feed mat smaller in amount of power feed than other power feed mats.

A power feed management apparatus according to another aspect of the present disclosure includes a receiver that receives power feed information on an amount of power feed to a power feed target from each of a plurality of power feed mats, a specifying unit that specifies a first power feed mat smaller in amount of power feed than other power feed mats among the plurality of power feed mats, based on the received power feed information, and a notification unit that gives information on the first power feed mat specified by the specifying unit.

An information display apparatus according to yet another aspect of the present disclosure is an information display apparatus that shows information on each of a plurality of power feed mats. The information display apparatus includes an obtaining unit that obtains information on a first power feed mat smaller in amount of power feed than other power feed mats among the plurality of power feed mats, the first power feed mat being specified based on power feed information on an amount of power feed to a power feed target, the power feed information being obtained from each of the plurality of power feed mats, and a display on which information on the first power feed mat is shown.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an exemplary configuration of a power feed management system.

FIG. 2 is a diagram showing an exemplary construction of a power feed mat in the present embodiment.

FIG. 3 is a diagram showing an exemplary state during use of the power feed mat.

FIG. 4 is a diagram for illustrating an exemplary configuration of an AGV fed with power from the power feed mat and an exemplary configuration of a power feed control device.

FIG. 5 is a diagram showing a specific example of a configuration of the power feed management system.

FIG. 6 is a flowchart showing exemplary processing performed in the power feed control device and a management server.

FIG. 7 is a diagram showing an exemplary image shown on a screen of a display.

FIG. 8 is a diagram showing an exemplary image shown on the screen of the display in a modification.

FIG. 9 is a diagram for illustrating a method of setting an expected amount of power feed. FIG. 10 is a diagram showing in a table format, an SOC of an electrically powered vehicle belonging to a vehicle group that passes by a first point.

FIG. 11 is a diagram showing in a table format, an SOC of an electrically powered vehicle belonging to a vehicle group that passes by a second point.

FIG. 12 is a flowchart showing exemplary processing performed in the management server in the modification.

### DESCRIPTION OF THE PREFERRED EMBODIMENTS

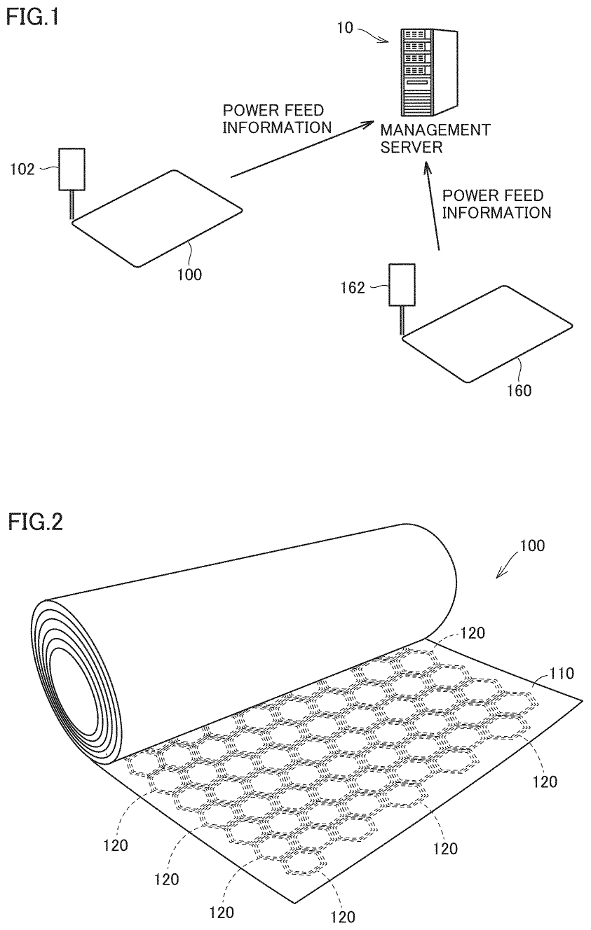

An embodiment of the present disclosure will be described in detail below with reference to the drawings. The same or corresponding elements in the drawings have the same reference characters allotted and description thereof will not be repeated. FIG. 1 is a diagram schematically showing an exemplary configuration of a power feed management system 1. As shown in FIG. 1, power feed management system 1 includes a management server 10, power feed mats 100 and 160, and power feed control devices 102 and 162.

Power feed mat 100 is in a rectangular two-dimensional shape, and constructed by embedment of a plurality of power transmission coils in a flexible mat member. Power feed mat 100 is constructed such that a placement position thereof is movable. A detailed construction of power feed mat 100 will be described later.

Power feed control device 102 is connected to power feed mat 100 as being attachable to and removable from the same. A not-shown power supply is further connected to power feed control device 102. Power feed control device 102 is configured to allow electric power supplied from the power supply to be supplied to power feed mat 100. When power feed control device 102 senses, for example, movement of a power feed target to power feed mat 100, it controls electric power to be supplied from the power supply to power feed mat 100 so as to achieve power feed to the power feed target on power feed mat 100. Power feed control device 102 transmits to management server 10, information (which is denoted as power feed information below) on an amount of power (which is denoted as an amount of power feed below) to be supplied from power feed mat 100 to the power feed target.

Since power feed mat 160 and power feed control device 162 are similar in configuration to power feed mat 100 and power feed control device 102, respectively, except for a placement position, detailed description thereof will not be repeated.

For example, a computer including a processor such as a central processing unit (CPU), a memory such as a random access memory (RAM) or a read only memory (ROM), a storage of a large capacity such as a hard disk drive (HDD) or a solid state drive (SSD), and a communication interface (I/F) can be adopted as management server 10. In this embodiment, various types of processing in management server 10 are performed by execution by the processor of a program stored in the memory or the storage.

Management server 10 is configured to establish wired or wireless communication with each of power feed control devices 102 and 162. Management server 10 obtains information on an amount of power feed in power feed mat 100 from power feed control device 102 through communication. Furthermore, management server 10 obtains information on an amount of power feed in power feed mat 160 from power feed control device 162 through communication.

Though a configuration in which management server 10 obtains power feed information of power feed mats 100 and 160 from two power feed control devices 102 and 162 is shown by way of example in FIG. 1, the number of sets of power feed control device and power feed mat managed by management server 10 is not limited to two, and three or more sets of power feed control device and power feed mat may be set and power feed information may be obtained from each power feed control device. For example, management server 10 can compare amounts of power feed or the like of a plurality of power feed mats including power feed mats 100 and 160 based on power feed information obtained from a plurality of power feed control devices including power feed control devices 102 and 162.

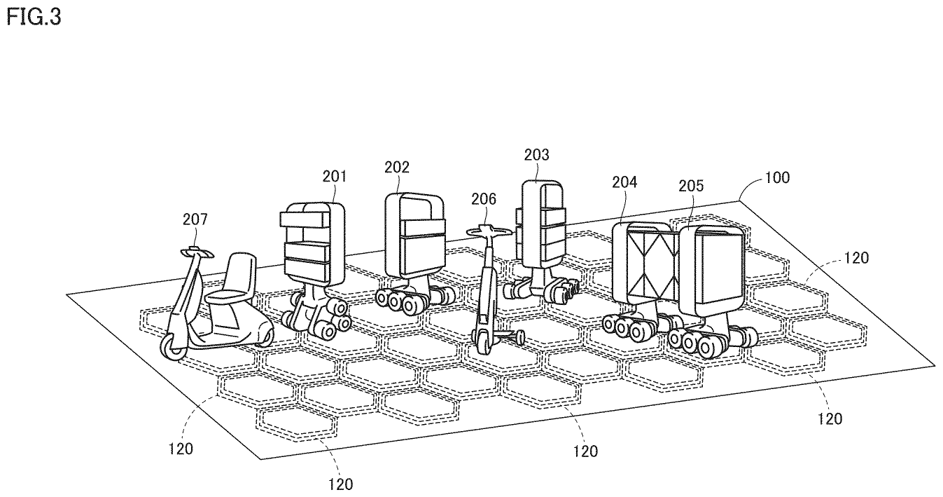

An exemplary detailed construction of power feed mat 100 will be described below with reference to FIG. 2. FIG. 2 is a diagram showing an exemplary construction of power feed mat 100 in the present embodiment. Referring to FIG. 2, power feed mat 100 includes a sheet substrate 110 and a plurality of power transmission coils 120 provided in the inside of sheet substrate 110. Power feed mat 100 is constructed as being portable. Power feed mat 100 is flexible to such an extent as being rolled into a cylinder. FIG. 2 shows power feed mat 100 partially rolled into a cylinder by way of example. Power feed mat 100 is used as being developed (see FIG. 3 which will be described later). Power feed mat 100 is constructed as being placed on a floor indoors or outdoors. Power feed mat 100 may be placed on the floor and thereafter fixed by a removable retainer (for example, retaining hardware or a gripper).

In this embodiment, power feed mat 100 in a developed state is assumed to have a rectangular outer geometry (two-dimensional shape). The outer geometry of power feed mat 100 is not limited to the rectangular shape but can be modified as appropriate. Power feed mat 100 may have an outer geometry in a polygonal shape (a triangular shape, a pentagonal shape, a hexagonal shape, or the like) other than a quadrangular shape, or a circular shape. In this embodiment, a plurality of power transmission coils 120 included in power feed mat 100 are contained in sheet substrate 110. Power transmission coils 120 may be provided as being exposed at a front or rear surface of power feed mat 100. Though sheet substrate 110 is formed of a material such as a resin, a material for sheet substrate 110 can be modified as appropriate. Though power transmission coil 120 is formed of a material such as a metal, a material for power transmission coil 120 can be modified as appropriate. Power transmission coil 120 may be formed, for example, of a conductive resin.

In this embodiment, on a mat surface (a main surface of power feed mat 100), the plurality of power transmission coils 120 are regularly disposed in matrix of rows and columns. Power transmission coils 120 are arranged, for example, in grids. Without being limited as such, arrangement of power transmission coils 120 can be modified as appropriate. Power transmission coils 120 may irregularly be arranged. Though power transmission coil 120 is formed in a regular hexagonal shape in a plan view in an example shown in FIG. 2, a shape of power transmission coil 120 can be modified as appropriate. A two-dimensional shape of power transmission coil 120 may be a polygonal shape (for example, a quadrangular shape) other than the hexagonal shape, or a circular or oval shape. A size of power transmission coil 120 may also be modified as appropriate in conformity with an application (for example, a structure of a movable body that uses power feed mat 100) of power feed mat 100.

FIG. 3 is a diagram showing an exemplary state during use of power feed mat 100. In an example shown in FIG. 3, a plurality of movable bodies 201 and 207 are on power feed mat 100. The plurality of power transmission coils 120 included in power feed mat 100 are configured to individually feed power to a plurality of movable bodies on power feed mat 100. When alignment between any one power transmission coil 120 included in power feed mat 100 and any one of movable bodies 201 to 207 is completed, electric power can wirelessly be fed from power transmission coil 120 that has been aligned to the movable body (any one of movable bodies 201 to 207). Each of movable bodies 201 to 207 can select one of the plurality of power transmission coils 120 included in power feed mat 100 and can be fed with power from selected power transmission coil 120. Any wireless power transfer (WPT) technique may be applicable, and magnetic resonance or electromagnetic induction power transmission may be applicable. Another technique may be adopted.

Each of movable bodies 201 to 207 is a small battery electric vehicle (BEV) configured to travel indoors or outdoors. For example, an automated guided vehicle (AGV) is illustrated as each of movable bodies 201 to 205. For example, a single-person battery electric vehicle is illustrated as each of movable bodies 206 and 207.

Movable bodies 201 to 205 are AGVs of the same type. Each of movable bodies 201 to 205 is used for load transport or the like. In the example shown in FIG. 3, each of movable bodies 201 to 203 carries a load alone. Movable bodies 204 and 205 carry in cooperation, a large load that cannot be carried by one movable body. Each of movable bodies 201 to 205 is referred to as an “AGV 200” below unless they are described as being distinguished from one another.

Each of movable bodies 206 and 207 is configured to be adapted to both of manual drive by a driver on-board and autonomous travel without human intervention. Movable body 206 includes a handlebar. Movable body 207 includes a handlebar and a seat.

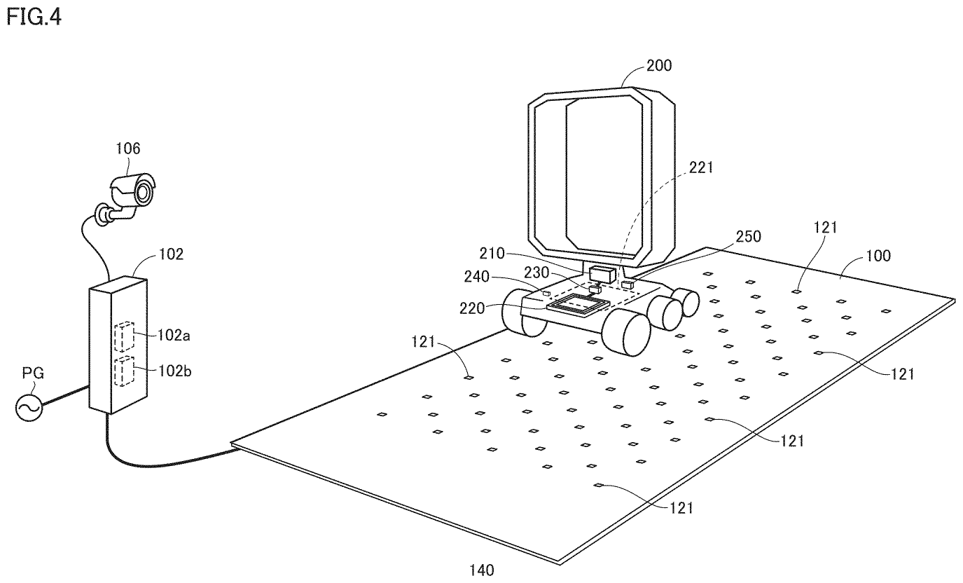

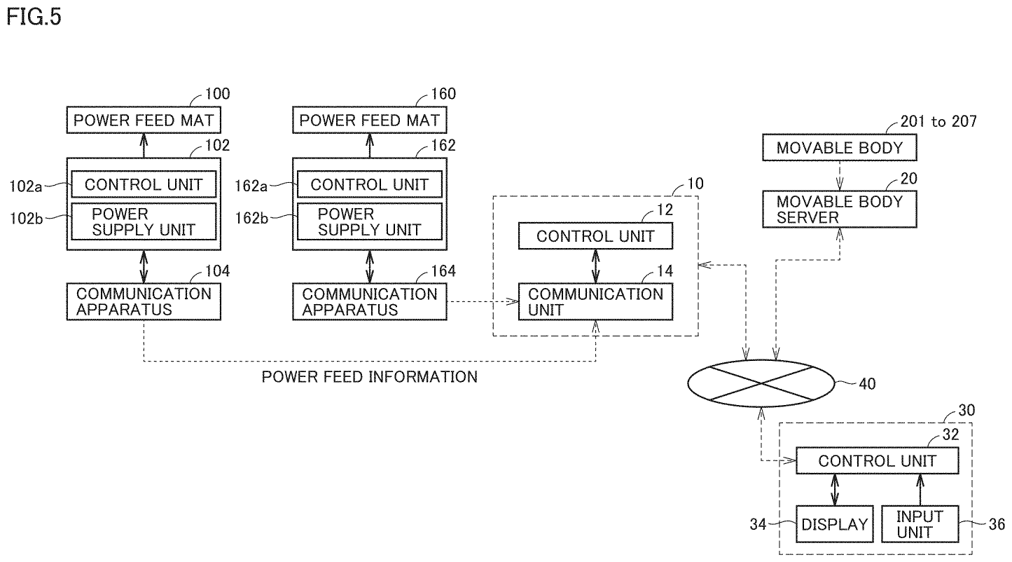

FIG. 4 is a diagram for illustrating an exemplary configuration of AGV 200 fed with power from power feed mat 100 and an exemplary configuration of power feed control device 102.

Referring to FIG. 4 together with FIG. 3, power feed management system 1 according to this embodiment further includes a camera 106 in addition to power feed mat 100 and power feed control device 102. Power feed control device 102 is electrically connected to power feed mat 100 through a cable. Power feed control device 102 includes a control unit 102a and a power supply unit 102b.

Control unit 102a controls electric power to be supplied to power feed mat 100 by power supply unit 102b. Furthermore, control unit 102a obtains power feed information based on results of detection by various sensors provided in power supply unit 102b. Control unit 102a transmits the obtained power feed information to management server 10. A computer including a processor, a memory, a storage, and a communication I/F can be adopted as control unit 102a. In this embodiment, various types of control in power feed control device 102 are carried out by execution by the processor of a program stored in the memory or the storage in control unit 102a. Various types of control in power feed control device 102 are not limited to control carried out by software but can also be carried out by dedicated hardware (electronic circuitry).

Power supply unit 102b is configured to receive supply of electric power from a power grid PG and to supply electric power to each of the plurality of power transmission coils 120 included in power feed mat 100. Power grid PG is an electric power network constructed of a power plant and a power transmission and distribution facility that are not shown. Power grid PG supplies alternating-current (AC) power (for example, three-phase AC power) to power feed control device 102. Power supply unit 102b uses, for example, a power conversion circuit (not shown) to convert electric power supplied from power grid PG into electric power suitable for wireless power feed and supplies resultant electric power to each power transmission coil 120 electrically connected to power supply unit 102b. For example, a resonance circuit (for example, an LC resonance circuit), a filter circuit, an inverter, and a power factor correction (PFC) circuit may be included as the power conversion circuit.

Control unit 102a obtains an amount of power supplied from power grid PG through power supply unit 102b to power feed mat 100, for example, based on results of detection by a voltage sensor and a current sensor that are not shown. Control unit 102a obtains the amount of power supplied to power feed mat 100 through power supply unit 102b, for example, as an amount of power feed to a power feed target on power feed mat 100.

Camera 106 is configured to receive supply of electric power from power feed control device 102 and to pick up an image of an area around power feed mat 100 from above power feed mat 100. Camera 106 may be attached to a wall. Alternatively, a post on which camera 106 is supported may be provided. Camera 106 contains, in addition to an image pick-up element, a processor and an image processing circuit that analyze video images obtained by the image pick-up element. Camera 106 picks up an image of the entire surface of power feed mat 100 and identifies an object (a living body or a substance) present on power feed mat 100. Management server 10 can monitor a state of power feed mat 100 with the use of camera 106. Camera 106 transmits obtained video images or a result of analysis obtained with the use of an image processing circuit to management server 10 through power feed control device 102. Camera 106 may transmit the obtained video images or the result of analysis to management server 10 not via power feed control device 102.

Power feed mat 100 further includes in the inside of sheet substrate 110 (FIG. 2), a plurality of magnetic markers 121. A plurality of magnetic markers 121 are provided in correspondence with the plurality of power transmission coils 120, respectively. In other words, magnetic marker 121 is provided for each power transmission coil 120 included in power feed mat 100. Magnetic marker 121 indicates a position of corresponding power transmission coil 120. By detecting magnetism emitted from magnetic marker 121 with a magnetic sensor, the movable body can detect the position of power transmission coil 120 corresponding to magnetic marker 121.

AGV 200 includes a battery 210, a power reception coil 220 that wirelessly receives electric power from power transmission coil 120, a charging circuit 230 that charges battery 210 with electric power received by power reception coil 220, a wireless communication instrument 240, and an electronic control unit (ECU) 250 that controls charging circuit 230.

A known power storage for a vehicle (for example, a liquid secondary battery, an all-solid secondary battery, or a battery assembly) can be adopted as battery 210. Examples of the secondary battery for the vehicle include a lithium ion battery or a nickel metal hydride battery. Instead of the secondary battery, another power storage such as an electric double layer capacitor may be adopted. Charging circuit 230 functions as a vehicle-mounted charger of battery 210. A computer including a processor, a memory, a storage, and a communication I/F can be adopted as ECU 250. In this embodiment, various types of control in AGV 200 are carried out by execution by the processor of a program stored in the memory or the storage in ECU 250. Various types of control in AGV 200 are not limited to control carried out by software but can also be carried out by dedicated hardware (electronic circuitry).

AGV 200 is an autonomous vehicle configured to travel with electric power stored in battery 210 without human intervention. Though not particularly shown, AGV 200 further includes an electric motor, a battery management system (BMS), an autonomous driving sensor, and a navigation system including map information. AGV 200 travels with motive power generated by the electric motor by supply of electric power to the electric motor from battery 210. The BMS includes various sensors that detect a state (for example, a current, a voltage, and a temperature) of battery 210 and a result of detection is provided to ECU 250. For example, the BMS detects charging power (a charging current and a charging voltage) of battery 210. The BMS estimates a state of charge (SOC) of battery 210 and a result of estimation is provided to ECU 250.

The autonomous driving sensor is a sensor used for autonomous driving. The autonomous driving sensor, however, may be used for prescribed control while autonomous driving is not being carried out. The autonomous driving sensor includes a sensor that obtains information for recognizing an environment outside AGV 200 and a sensor that obtains information on a position and an attitude of AGV 200. The autonomous driving sensor may include, for example, at least one of a camera, a millimeter wave radar, and a lidar. The autonomous driving sensor may include, for example, at least one of an inertial measurement unit (IMU) and a global positioning system (GPS) sensor.

AGV 200 is configured to autonomously travel in accordance with a prescribed travel schedule without human intervention. The travel schedule includes, for example, time of departure for a destination and time of arrival at the destination. The travel schedule may be set with any method. For example, a user may operate a user terminal (for example, a mobile terminal) capable of wirelessly communicating with AGV 200 to set a travel schedule and a destination in ECU 250. Alternatively, the user may operate a service tool connected to establish wired communication with AGV 200 or a human machine interface (HMI) of AGV 200 to set a travel schedule and a destination in ECU 250. For example, when the SOC of battery 210 is low, AGV 200 sets a stand-by location provided with power feed mat 100 as the destination and moves to the set destination. When AGV 200 moves to the stand-by location, it charges battery 210. Alternatively, for example, when AGV 200 passes over power feed mat 100 while it moves, AGV 200 charges battery 210 while it moves over power feed mat 100.

ECU 250 is configured to carry out autonomous driving (including autonomous parking) in accordance with a prescribed autonomous driving program. ECU 250 controls an accelerator, a brake, and a steering apparatus (none of which is shown) of AGV 200 based on various types of information obtained by the autonomous driving sensor, to thereby carry out autonomous driving of AGV 200 in accordance with a travel route and the travel schedule. The autonomous driving program may sequentially be updated by Over the Air (OTA).

Charging circuit 230 is connected between battery 210 and power reception coil 220 and controlled by ECU 250. Charging circuit 230 includes a power conversion circuit. When battery 210 is charged with electric power supplied from power transmission coil 120 to power reception coil 220, ECU 250 controls charging circuit 230 such that appropriate electric power is provided from power reception coil 220 to battery 210. Charging circuit 230 converts AC power provided from power reception coil 220 into direct-current (DC) power and provides DC power to battery 210. Specifically, charging circuit 230 may include a resonance circuit (for example, an LC resonance circuit), a filter circuit, or a rectification circuit.

AGV 200 further includes a position sensor module 221 that detects a position of AGV 200 on the mat surface (the main surface of power feed mat 100). Position sensor module 221 is used, for example, for alignment between any power transmission coil 120 of power feed mat 100 and power reception coil 220. Position sensor module 221 is provided, for example, on a bottom surface of AGV 200. Position sensor module 221 includes a plurality of magnetic sensors. The plurality of magnetic sensors may be arranged in grids. Each magnetic sensor included in position sensor module 221 detects magnetism emitted from magnetic marker 121. ECU 250 is configured to obtain an amount of position displacement between power transmission coil 120 and power reception coil 220 based on a result of detection by position sensor module 221.

In this embodiment, power feed control device 102 and AGV 200 are configured to communicate with each other with the use of a communication apparatus. For example, power feed control device 102 and ECU 250 may wirelessly communicate with each other. Any communication method is applicable. For example, power feed control device 102 and ECU 250 may be configured to establish short-range communication (for example, direct communication within an area around power feed mat 100) such as near field communication (NFC) or Bluetooth®. Alternatively, power feed control device 102 and ECU 250 may be configured to wirelessly communicate with each other by using a wireless local area network (LAN). AGV 200 may include a radio frequency identification (RFID) apparatus. Then, power feed control device 102 may be configured to receive a signal emitted from the RFID apparatus of AGV 200. Power feed control device 102 obtains at least a movable body ID (which will be described later) from AGV 200 to which power is to be fed. For example, in charging on power feed mat 100, AGV 200 transmits the movable body ID to power feed control device 102 at prescribed timing.

Though the configuration of AGV 200 is described above, each of movable bodies 206 and 207 shown in FIG. 3 also contains a configuration similar to the configuration shown in FIG. 4. The circuit configuration described above may be modified as necessary to perform similar functions.

FIG. 5 is a diagram showing a specific example of a configuration of power feed management system 1. Referring to FIG. 5, power feed management system 1 further includes a movable body server 20, a terminal 30, a communication network 40, and communication apparatuses 104 and 164 in addition to management server 10, power feed mats 100 and 160, and power feed control devices 102 and 162.

Management server 10, movable body server 20, and terminal 30 are configured to communicate with one another over communication network 40.

Management server 10 includes a control unit 12 configured with a processor and a communication unit 14 configured with a communication I/F. Management server 10 is configured to communicate with the outside through communication unit 14.

Management server 10 is configured to communicate with each of a plurality of movable bodies (for example, movable bodies 201 to 207 shown in FIG. 3) that can use power feed mats 100 and 160 over communication network 40 through movable body server 20. Furthermore, management server 10 is configured to communicate with terminal 30 over communication network 40. Management server 10 may communicate with movable body server 20 or terminal 30, for example, through wireless or wired communication.

For example, information (which is denoted as mat information below) on each of a plurality of power feed mats including power feed mats 100 and 160 shown in FIGS. 1 to 4 is stored in management server 10. Management server 10 updates the mat information stored in a storage at any time. The mat information includes, for example, identification information (which is denoted as a mat ID below) for identifying a power feed mat, specifications of the power feed mat (for example, specs relating to power feed), and position information on a placement position of the power feed mat. The mat ID is given, for example, to each of the plurality of power feed mats. The mat ID described above and the specifications and the position information of the power feed mat are stored in management server 10 in association. Management server 10 corresponds to the “management apparatus” and the “power feed management apparatus” that manage a power feed state of each of the plurality of power feed mats.

A computer including a processor, a memory, a storage, and a communication I/F can be adopted as movable body server 20. In this embodiment, various types of processing in movable body server 20 are performed by execution by the processor of a program stored in the memory or the storage.

Movable body server 20 manages information on each of movable bodies 201 to 207 (which is denoted as movable body information below). The movable body information includes, for example, identification information (which is denoted as a movable body ID below) for identifying movable bodies 201 to 207, movement history information representing a history of positions including current positions of movable bodies 201 to 207, and state-of-charge (SOC) history information on a history of the SOC including a current value of a power storage (battery 210 or the like) mounted on the movable body. The movable body ID is registered in advance, for example, in movable body server 20, and movable body server 20 can identify, based on the movable body ID included in the movable body information, information on which of movable bodies 201 to 207 the movable body information is. Movable body server 20 is configured, for example, to wirelessly communicate with movable bodies 201 to 207. Movable body server 20 may wirelessly communicate with an unregistered movable body that has not yet been registered and obtain movable body information from the unregistered movable body. Movable bodies 201 to 207 transmit movable body information to movable body server 20 at predetermined timing while they move. Movable body server 20 updates the movable body information stored therein with the received movable body information.

For example, when management server 10 receives the movable body ID from a movable body that has moved to power feed mat 100, management server 10 requests movable body server 20 to give movable body information corresponding to the received movable body ID.

Movable body server 20 transmits the movable body information corresponding to the movable body ID among movable bodies 201 to 207 to management server 10 in response to a request from management server 10. Movable body server 20 may transmit the movable body information to management server 10, for example, each time the movable body information is updated.

The received movable body information and the mat information are stored in management server 10 in association. For example, management server 10 specifies a power feed mat from which power is to be fed, based on the movable body ID and the position information included in the received movable body information, and the mat information on the specified power feed mat and the received movable body information may be stored in management server 10 in association.

Terminal 30 is configured to obtain power feed information of the plurality of power feed mats managed by management server 10 or movable body information of the plurality of movable bodies 201 to 207 managed by movable body server 20.

Terminal 30 includes a control unit 32, a display 34, and an input unit 36. Control unit 32 is configured with a processor such as a CPU. Display 34 is configured with a liquid crystal display (LCD) or an organic electro luminescence (EL) display to show text information or an image. Input unit 36 is configured with a device such as a touch panel, a keyboard, or a mouse that accepts an operation by a user. Terminal 30 is configured to communicate with management server 10 or movable body server 20 through a not-shown communication unit over communication network 40. Terminal 30 may be, for example, a terminal such as a personal computer or a portable terminal such as a smartphone. Terminal 30 is operated, for example, by a manager that manages a power feed state of a plurality of power feed mats. For example, when terminal 30 accepts a prescribed operation onto input unit 36, it obtains prescribed information from management server 10. The prescribed information includes, for example, information for providing prescribed representation on display 34. In the present embodiment, the prescribed information includes map information. The map information includes map information of surroundings of placement positions of a plurality of power feed mats including power feed mats 100 and 160, information representing placement positions of the plurality of power feed mats on a map, and information representing a power feed state of the power feed mats. For example, control unit 32 performs processing for performing operations described above with the use of application software. Terminal 30 corresponds to the information display apparatus that shows information on each of a plurality of power feed mats.

Since the plurality of power feed mats are constructed as being portable in power feed management system 1 configured as above, the placement positions thereof can freely be set. When power feed mats are placed at a plurality of locations, a plurality of electrically powered vehicles that can use the power feed mats use power feed mats placed on a travel path or power feed mats placed at a closest stand-by location. Consequently, the number of visiting electrically powered vehicles may be imbalanced among the plurality of power feed mats. Since the power feed mats are constructed to be movable, in order to suppress the imbalance as described above also after placement, it is required to specify whether or not a placement position of each of the plurality of power feed mats is appropriate.

In the present embodiment, management server 10 is assumed to specify a first power feed mat smaller in amount of power feed than other power feed mats among a plurality of power feed mats, based on power feed information received from each of the plurality of power feed mats.

Thus, the first power feed mat lower in utilization efficiency than other power feed mats can be specified based on the power feed state of the plurality of power feed mats. Furthermore, by changing the specified placement position of the first power feed mat, imbalance in amount of power feed among the plurality of power feed mat can be eliminated.

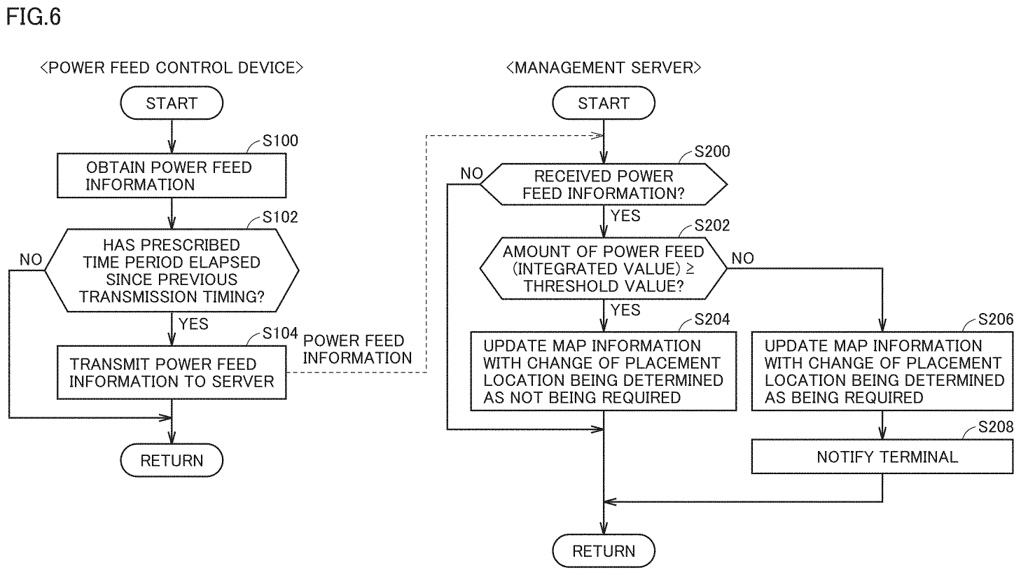

Exemplary processing performed in power feed control device 102 and management server 10 will be described below with reference to FIG. 6. FIG. 6 is a flowchart showing exemplary processing performed in power feed control device 102 and management server 10. A series of processing shown in the flowchart on the left in FIG. 6 is repeatedly performed by power feed control device 102 every prescribed control cycle. A series of processing shown in the flowchart on the right in FIG. 6 is repeatedly performed by management server 10 every prescribed control cycle. The processing performed by power feed control device 102 will be described below. The processing below is performed in each of the plurality of power feed control devices corresponding to the plurality of power feed mats.

As shown in the flowchart on the left in FIG. 6, in step (the step being denoted as S below) 100, power feed control device 102 obtains power feed information. Power feed control device 102 obtains an amount of power feed from a corresponding power feed mat to a power feed target (movable body). Power feed control device 102 integrates the amount of power feed obtained over a period from previous transmission timing until lapse of a prescribed time period. In S102, power feed control device 102 determines whether or not the prescribed time period has elapsed since previous transmission timing. For example, when a timer count value is larger than a value corresponding to the prescribed time period, power feed control device 102 determines that the prescribed time period has elapsed since previous transmission timing. Power feed control device 102 resets the timer count value to an initial value (for example, zero) at timing of transmission of previous power feed information to management server 10 and starts the timer. When the timer is started, a prescribed value is added to the count value at prescribed intervals (every prescribed control cycle). For example, immediately after start of power feed, timing of start of power feed is set as the timing of transmission of previous power feed information to management server 10.

When it is determined that the prescribed time period has elapsed since previous transmission timing (YES in S102), the process proceeds to S104. When it is determined that the prescribed time period has not elapsed since previous transmission timing (NO in S102), this process ends,

In S104, power feed control device 102 transmits the power feed information to management server 10. Power feed control device 102 transmits as power feed information to management server 10, an integrated value of the amount of power feed over a period from immediately after the previous transmission timing until a time point of lapse of the prescribed time period. At this time, power feed control device 102 transmits a mat ID in association with information on the amount of power feed to management server 10. Thereafter, power feed control device 102 resets the integrated value of the amount of power feed to an initial value (for example, zero).

Processing performed in management server 10 will now be described. As shown in the flowchart on the right in FIG. 6, in 5200, management server 10 determines whether or not it has received the power feed information from a power feed control device corresponding to at least any one of the plurality of power feed mats. When the management server determines that it has received the power feed information (YES in S200), the process proceeds to S202.

In S202, management server 10 determines whether or not the amount of power feed included in the received power feed information is equal to or larger than a threshold value (which may be denoted as a prescribed value below). For example, a predetermined value may be set as the threshold value, or a value smaller by a predetermined value than an average value of amounts of power feed of the plurality of power feed mats over a recent predetermined period may be set as the threshold value. When the management server determines that the amount of power feed is equal to or larger than the threshold value (YES in S202), the process proceeds to S204.

In S204, management server 10 updates the map information determining the power feed mat corresponding to the received power feed information as a power feed mat a placement position of which does not have to be changed.

The map information includes, for example, map information (including a map image or information on a facility nearby) on a map of a region where a power feed mat is placed, information representing placement positions of a plurality of power feed mats on the map, information for showing an amount of power feed of each of the plurality of power feed mats, and information (for example, a flag) indicating whether or not a placement position of each of the plurality of power feed mats has to be changed.

Management server 10 specifies a power feed mat which is a sender of the power feed information among the plurality of power feed mats, based on the mat ID included in the received power feed information. Management server 10 sets information indicating that the placement position of the specified power feed mat does not have to be changed (for example, sets the flag indicating whether or not the placement position has to be changed to an off state).

When the amount of power feed is determined as being smaller than the threshold value (NO in S202), the process proceeds to S206.

In S206, management server 10 updates the map information regarding the power feed mat corresponding to the received power feed information as a power feed mat a placement position of which has to be changed (corresponding to the first power feed mat described above).

Management server 10 specifies a power feed mat which is the sender of the power feed information among the plurality of power feed mats, based on the mat ID included in the received power feed information. Management server 10 sets information indicating that the placement position of the specified power feed mat has to be changed (for example, sets the flag indicating whether or not the placement position has to be changed to an on state).

In S208, management server 10 transmits the map information to terminal 30. When terminal 30 receives the map information from management server 10, it shows the received map information on display 34. Terminal 30 shows in an image shown on display 34, the power feed mat the placement position of which has to be changed, in a manner of display different from that of other power feed mats the placement position of which does not have to be changed. Thus, in the image shown on display 34, a user can more readily specify the power feed mat the placement position of which has to be changed. Furthermore, when a power feed mat the placement position of which has to be changed is shown on terminal 30, text information inviting the user to change the placement position of the power feed mat may additionally be shown on display 34.

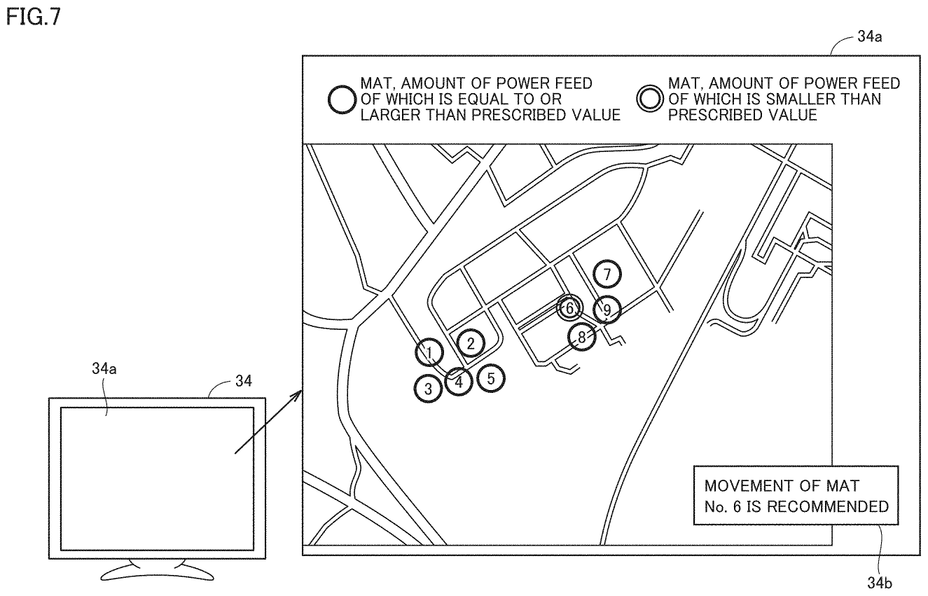

An operation of power feed management system 1 based on the structure and the flowchart as above will be described with reference to FIG. 7. FIG. 7 is a diagram showing an exemplary image shown on a screen 34a of display 34. FIG. 7 shows an example in which nine power feed mats are placed as the plurality of power feed mats by way of example. The nine power feed mats are provided with numbers from (1) to (9) as mat IDs, and a number in a circle (including a double circle) shown on the map in FIG. 7 represents the mat ID. A position of the circle indicates a position of placement of the power feed mat corresponding to the mat ID in the circle. When AGV 200 or another electrically powered vehicle moves to a power feed mat among the power feed mats labeled with (1) to (9), power feed from that power feed mat to the electrically powered vehicle is started.

For example, when AGV 200 moves to power feed mat 100, power feed from power feed mat 100 to AGV 200 is started. Power feed may be carried out while AGV 200 is moving or while AGV 200 remains stopped. As power feed is started, power feed control device 102 obtains power feed information (S100). The amount of power feed is integrated over a period from start of power feed until lapse of a prescribed time period, and when the prescribed time period has elapsed (YES in S102), the power feed information including the integrated value of the amount of power feed is transmitted to management server 10 (S104). Thereafter, the integrated value is reset to the initial value, and obtainment and integration of the amount of power feed are repeated over a period from timing of next transmission of the power feed information until lapse of the prescribed time period (S100). Then, after lapse of the prescribed time period since timing of transmission of previous power feed information (YES in S102), the integrated amount of power feed is transmitted again to management server 10 (S104). Such processing is performed each time the prescribed time period elapses.

Management server 10 determines whether or not it has received the power feed information (S200). For example, when the management server has received the power feed information from power feed control device 102 (YES in S200), it determines whether or not the integrated value of the amount of power feed included in the received power feed information is equal to or larger than the threshold value (S202). When the integrated value of the amount of power feed is determined as being equal to or larger than the threshold value (YES in S202), the map information is updated with power feed mat 100 corresponding to the mat ID included in the power feed information being determined as a power feed mat the placement position of which does not have to be changed (S204).

When the integrated value of the amount of power feed included in the power feed information received from power feed control device 102 is determined as being smaller than the threshold value (NO in S200), the map information is updated with power feed mat 100 being determined as a power feed mat the placement position of which has to be changed (S206). In this case, the updated map information is transmitted to terminal 30. Terminal 30 shows an image generated in accordance with the updated map information on display 34 (S208).

The exemplary operations described above represent exemplary operations by management server 10 when it receives power feed information from power feed control device 102, and management server 10 performs similar operations also when it receives power feed information from another power feed control device. Therefore, detailed description will not be repeated.

For example, when power feed mat 100 has the mat ID (6), the manner of display of the position corresponding to the power feed mat labeled with (6) is changed from the single circle indicating that the placement position does not have to be changed to the double circle indicating that the placement position has to be changed as shown in FIG. 7. Furthermore, text information that “movement of mat No. 6 is recommended” is shown at a position corresponding to a lower portion of a screen, which can have the user who sees screen 34a of display 34 recognize that power feed mat 100 labeled with (6) is the power feed mat the placement position of which has to be changed.

As set forth above, according to power feed management system 1 in the present embodiment, a power feed mat lower in utilization efficiency than other power feed mats can be specified based on the power feed state (amount of power feed) of the plurality of power feed mats. By giving information on that power feed mat with the use of display 34, the user can recognize information on the first power feed mat smaller in amount of power feed than other power feed mats. Therefore, the power feed management system, the power feed management apparatus, and the information display apparatus that can specify whether or not a placement position of each of a plurality of power feed mats is appropriate can be provided.

A modification will be described below.

The embodiment described above explains that map information is given to terminal 30 when the integrated value of the amount of power feed is smaller than the threshold value. The map information, however, may be given to terminal 30, for example, also when the integrated value of the amount of power feed is equal to or larger than the threshold value.

Furthermore, the embodiment described above explains that the map information is given to terminal 30 when the integrated value of the amount of power feed is smaller than the threshold value. The map information, however, may be given to terminal 30 when terminal 30 issues a request to do so. Alternatively, the image as shown in FIG. 7 may be published on a specific website, and the image may be shown on display 34 of terminal 30 by access to the website by terminal 30.

Furthermore, the embodiment described above explains that power feed control device 102 integrates the amount of power feed over a period until lapse of the prescribed time period and the integrated value of the amount of power feed is transmitted as the power feed information from power feed control device 102 to management server 10 each time the prescribed time period elapses. Power feed control device 102, however, may transmit the amount of power feed to management server 10 each time it obtains the amount of power feed, and may calculate the integrated value of the amount of power feed over a prescribed time period based on the amount of power feed received by management server 10.

Furthermore, the embodiment described above explains that a notification about a power feed mat the placement position of which has to be changed is given with the use of display 34 of terminal 30 as shown in FIG. 7 by way of example. A new placement position, however, may be specified, and terminal 30 may be notified of the specified new placement position in addition to information on the power feed mat the placement position of which has to be changed.

For example, management server 10 divides a prescribed region including positions of placement of a plurality of power feed mats into a plurality of sub regions and calculates an expected amount of power feed in each sub region. By calculation of the expected amount of power feed in each sub region, a placement position expected to be larger in amount of power feed than a position where the power feed mat the placement position of which has to be changed is placed can be specified. For example, by visually showing the calculated expected amount of power feed in each sub region, management server 10 can have the user specify a new placement position.

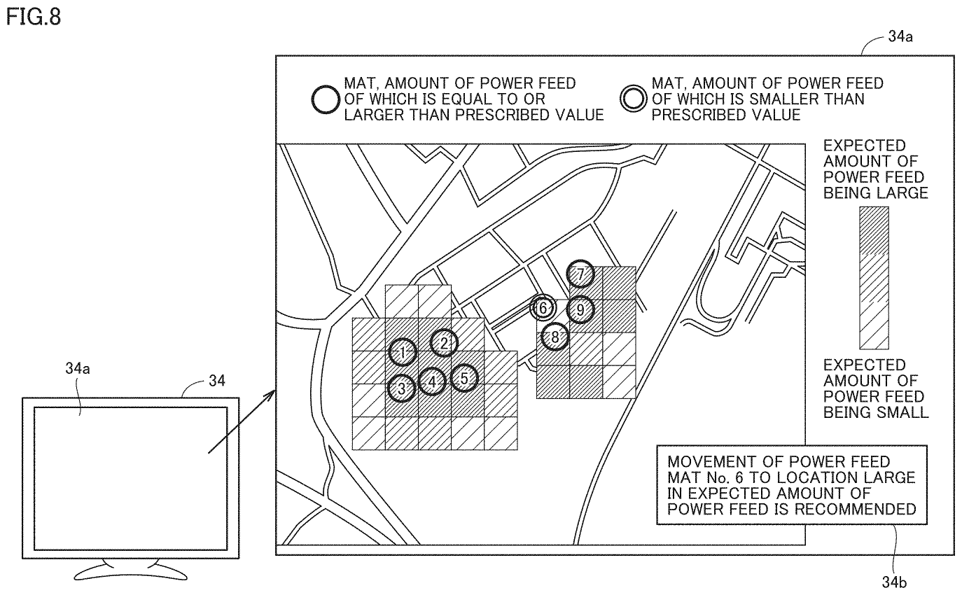

A method of calculating an expected amount of power feed will be described below. Management server 10 divides a prescribed region including positions of placement of a plurality of power feed mats into a plurality of sub regions. For example, FIG. 8 is a diagram showing an exemplary image shown on screen 34a of display 34 in the modification. The image shown in FIG. 8 is different from the map information shown in FIG. 7 in including a plurality of rectangular regions each representing a degree of an expected amount of power feed in a sub region. The rectangular region corresponds to each sub region. FIG. 8 shows a region divided into twenty-one sub regions set to include placement positions of power feed mats labeled with (1) to (5) and a region divided into eleven sub regions set to include placement positions of power feed mats labeled with (6) to (9). A hatched portion within the rectangular region is shown with three kinds of patterns or colors. These three kinds of patterns or colors represent a degree of the expected amount of power feed at a reference point within each rectangular region. For example, a first region with densest hatching among the plurality of rectangular regions is shown as being higher in degree of the expected amount of power feed than other sub regions. A second region with sparsest hatching is shown as being lower in degree of the expected amount of power feed than other sub regions. A remaining third region is shown as being smaller in expected amount of power feed than the first region and being larger in expected amount of power feed than the second region. A distribution of the expected amounts of power feed in the plurality of sub regions is thus visually shown.

In other words, management server 10 specifies under which of three levels of the expected amount of power feed (large), the expected amount of power feed (intermediate), and the expected amount of power feed (small) the amount of power feed in each sub region falls, and has the rectangular region shown in a manner of display corresponding to the specified expected amount of power feed.

Management server 10 specifies an electrically powered vehicle that passes by the reference point in each sub region within a predetermined period, for example, by obtaining movable body information from movable body server 20. Management server 10 obtains information on the SOC of the specified electrically powered vehicle from the movable body information.

Management server 10 sets the expected amount of power feed in the case of placement of a power feed mat at the reference point in each sub region to any one of the three levels described above, based on information on the number of electrically powered vehicles that pass by the reference point in each sub region and the SOC of the power storage mounted on the electrically powered vehicle that passes. A point in each sub region where a power feed mat can be placed, a central point in each sub region, or a point on a travel path (on a road) of a vehicle may be set as the reference point in each sub region. Alternatively, a certain range within each sub region may be set as the reference point.

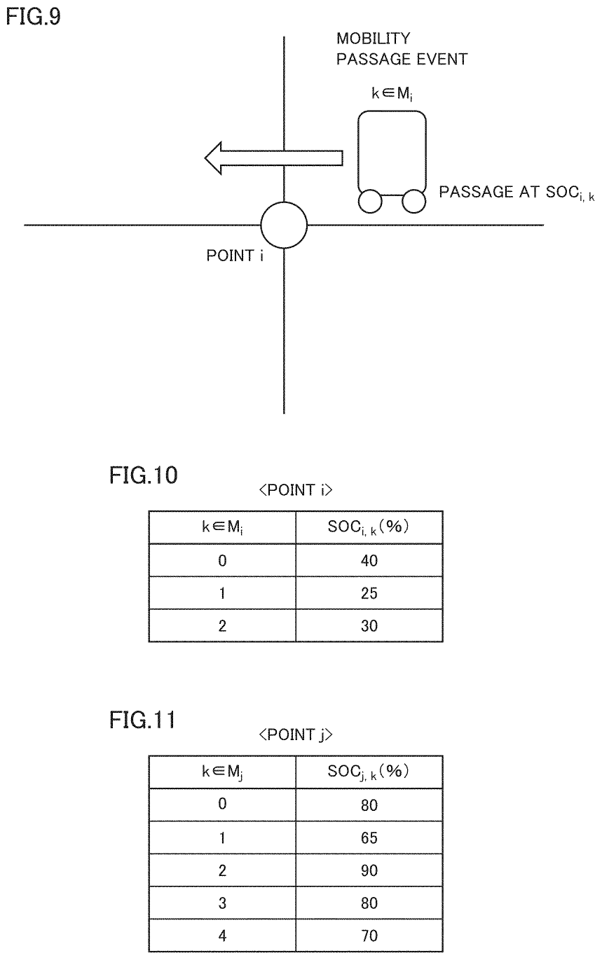

FIG. 9 is a diagram for illustrating an exemplary method of setting an expected amount of power feed. FIG. 9 shows an example in which an electrically powered vehicle passes by a reference point i (which is denoted as a first point i below) in any one of a plurality of sub regions. For example, a vehicle group that passes by first point i within a predetermined period is denoted as a vehicle group Mi. It is assumed that a single electrically powered vehicle k or a plurality of electrically powered vehicles k belong(s) to vehicle group Mi and that an SOC of the power storage mounted on electrically powered vehicle k is expressed as SOC (i, k).

FIG. 10 is a diagram showing in a table format, SOC (i, k) of electrically powered vehicle k belonging to vehicle group Mi that passes by first point i. FIG. 10 shows that three electrically powered vehicles belong to vehicle group Mi that passes by point i within a predetermined period and that SOC (i, 0) of the power storage of the electrically powered vehicle (k=0) that passes first is 40%. FIG. 10 further shows that SOC (i, 1) of the power storage of the electrically powered vehicle (k=1) that passes next is 25%. Then, FIG. 10 shows that SOC (i, 2) of the power storage of the electrically powered vehicle (k=2) that passes last is 30%.

Management server 10 calculates ΔSOC (i, k) short of 100% SOC, for example, of each of these three electrically powered vehicles. Management server 10 calculates the sum (=205%) of calculated ΔSOC (i, k) of the three electrically powered vehicles. For example, management server 10 calculates an amount of power corresponding to the sum of ΔSOC (i, k) as a maximum value of the amount of power that can be fed at point i, and determines under which of the three levels the expected amount of power feed falls, based on the calculated value. For example, a first threshold value for the expected amount of power feed and a second threshold value larger than the first threshold value are set in advance. When the calculated value is smaller than the first threshold value, management server 10 determines the expected amount of power feed as the expected amount of power feed (small). When the calculated value is equal to or larger than the first threshold value and equal to or smaller than the second threshold value, management server 10 determines the expected amount of power feed as the expected amount of power feed (intermediate). When the calculated value is larger than the second threshold value, management server 10 determines the expected amount of power feed as the expected amount of power feed (large).

A vehicle group that passes by a reference point j (which is denoted as a second point j below) in a sub region different from the sub region including first point i in a prescribed region is denoted as a vehicle group Mj. It is assumed that a single electrically powered vehicle k or a plurality of electrically powered vehicles k belong(s) to vehicle group Mj and that the SOC of the power storage mounted on electrically powered vehicle k is expressed as SOC (j, k).

FIG. 11 is a diagram showing in a table format, SOC (j, k) of electrically powered vehicle k belonging to vehicle group Mj that passes by second point j. FIG.

11 shows that five electrically powered vehicles belong to vehicle group Mj that passes by point j within a predetermined period and that SOC (j, 0) of the power storage of the electrically powered vehicle (k=0) that passes first is 80%. FIG. 11 shows that SOC (j, 1) of the power storage of the electrically powered vehicle (k=1) that passes next is 65%. FIG. 11 shows that SOC (j, 2) of the power storage of the electrically powered vehicle (k=2) that passes next is 90%. FIG. 11 further shows that SOC (j, 3) of the power storage of the electrically powered vehicle (k=3) that passes next is 80%. FIG. 11 shows that SOC (j, 4) of the power storage of the electrically powered vehicle (k 32 4) that passes last is 70%. Management server 10 calculates ΔSOC (j, k) short of 100% SOC, for example, of each of these five electrically powered vehicles. Management server 10 calculates the sum (=115%) of calculated ΔSOC (j, k) of the five electrically powered vehicles. For example, management server 10 calculates an amount of power corresponding to the sum of ΔSOC (j, k) as a maximum value of the amount of power that can be fed at point j, and determines under which of the three levels the expected amount of power feed falls, based on the calculated value.

Management server 10 sets the expected amount of power feed in all sub regions (at points) included in the prescribed region and has the expected amount of power feed visually shown on the map, the expected amount of power feed being set in each sub region as shown in FIG. 8.

Management server 10 may specify a new placement position based on the distribution of the expected amounts of power feed as shown in FIG. 8 and transmit the specified new placement position to terminal 30. For example, management server 10 may specify as the new placement position, any one sub region (for example, a sub region short in travel distance necessary for change of the placement position) among sub regions (points) allocated as the expected amounts of power feed (large) among the plurality of sub regions, and transmit the specified new placement position to terminal 30.

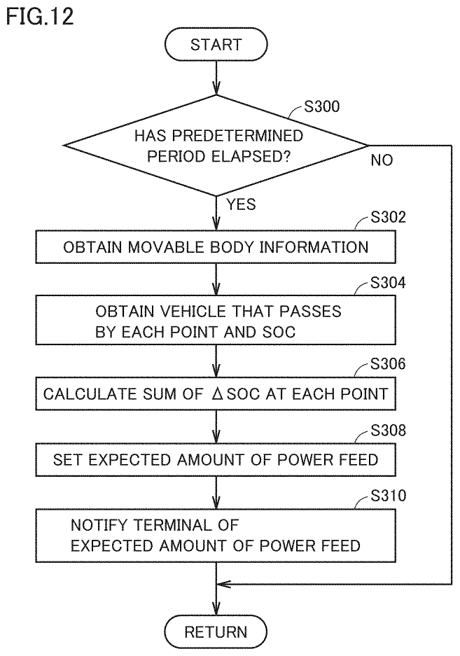

FIG. 12 is a flowchart showing exemplary processing performed in management server 10 in the modification. A series of processing shown in the flowchart in FIG. 12 is repeatedly performed by management server 10 every prescribed control cycle.

In S300, management server 10 determines whether or not a predetermined period has elapsed. Specifically, management server 10 determines whether or not a predetermined period has elapsed since a time point of notification about a previous expected amount of power feed to terminal 30 or a time point of start of calculation of the expected amount of power feed. The predetermined period may be set, for example, to a period around several hours or a period of one day or around several days. When the management server determines that the predetermined period has elapsed (YES in S300), the process proceeds to S302. When the management server determines that the predetermined period has not elapsed (NO in S300), the process ends.

In S302, management server 10 obtains movable body information. Management server 10 obtains from movable body server 20, movable body information over a predetermined period, of each movable body managed by movable body server 20.

In S304, management server 10 obtains a vehicle that passes by each point and the SOC. More specifically, management server 10 specifies a history of movement of each movable body based on position information in each piece of movable body information over the predetermined period, specifies the vehicle that passes by each point based on the specified history of movement, and obtains the SOC of the specified vehicle at the time point of passage by the point.

In S306, management server 10 calculates the sum of ΔSOC at each point. Since the method of calculating the sum of ΔSOC is as described above, detailed description thereof will not be repeated.

In S308, management server 10 sets the expected amount of power feed at each point to any one of the three levels based on the calculated sum of ΔSOC at each point.

In S310, management server 10 notifies terminal 30 of the expected amount of power feed set for each point. More specifically, management server 10 transmits information for providing representation of the distribution of the expected amounts of power feed as shown in FIG. 8 to terminal 30.

Management server 10 operates as below based on the flowchart as above. Specifically, when the predetermined period has elapsed since the time point of calculation of the previous expected amount of power feed (YES in S300), management server 10 obtains movable body information including the history of movement or a history of change of the SOC over the predetermined period from movable body server 20 (S302).

Management server 10 specifies a vehicle that passes by each point within the predetermined period based on the obtained movable body information and obtains the SOC at the time point of passage of the specified vehicle (S304).

Then, the sum of ΔSOC at each point is calculated (S306) and the expected amount of power feed at each point is set to any one of the three levels of the expected amount of power feed based on the calculated sum of ΔSOC (S308). Then, information including the set expected amount of power feed at each point is given to terminal 30 (S310). Terminal 30 generates the image as shown in FIG. 8 based on the information received from management server 10 and shows the image on screen 34a of display 34. At this time, by showing text information such as “movement of power feed mat No. 6 to location large in expected amount of power feed is recommended” as shown in FIG. 8, the user may be notified of change of the placement position and a new placement position.

This modification explains that any one of the three levels of the expected amount of power feed is set based on the sum of ΔSOC. An average value of SOCs of power storages mounted on a plurality of vehicles at each point, however, may be calculated and categorization into the three levels of the expected amount of power feed may be made based on the average value. For example, when the average value of the SOC is larger than a first threshold value, the expected amount of power feed (small) may be set on the assumption that there is no demand for charging. When the average value of the SOC is smaller than a second threshold value (<the first threshold value), the expected amount of power feed (large) may be set on the assumption that there is a demand for charging. When the average value of the SOC is equal to or smaller than the first threshold value and equal to or larger than the second threshold value, the expected amount of power feed (intermediate) may be set.

The modification further explains that any one of the three levels of the expected amount of power feed is set based on the sum of ΔSOC. When a full charge capacity is significantly different among a plurality of vehicles, however, the sum of amounts of power necessary for increasing SOCs of the vehicles from the current value to 100% may be calculated as the amount of power corresponding to the sum of ΔSOC and the expected amount of power feed may be set based on the calculated value.

The entirety or a part of the modification may be carried out as being combined as appropriate.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power feed management system comprising:
a plurality of power feed mats; and
a management apparatus that manages a power feed state of each of the plurality of power feed mats, wherein
the power feed mat generates power feed information on an amount of power feed to a power feed target and transmits the power feed information to the management apparatus, and
the management apparatus specifies a first power feed mat smaller in amount of power feed than other power feed mats among the plurality of power feed mats, based on the power feed information received from each of the plurality of power feed mats.

2. The power feed management system according to claim 1, wherein
the management apparatus
obtains position information of the power feed target that moves in a predetermined region provided with the plurality of power feed mats and a charging state of a power storage mounted on the power feed target, and
specifies a placement position where an amount of power feed larger than an amount of power feed at a placement position of the first power feed mat is expected, based on the position information and the charging state that have been obtained.

3. The power feed management system according to claim 1, further comprising a notification apparatus that gives information about the first power feed mat.

4. A power feed management apparatus comprising:
a receiver that receives power feed information on an amount of power feed to a power feed target from each of a plurality of power feed mats;
a specifying unit that specifies a first power feed mat smaller in amount of power feed than other power feed mats among the plurality of power feed mats, based on the received power feed information; and
a notification unit that gives information on the first power feed mat specified by the specifying unit.

5. An information display apparatus that shows information on each of a plurality of power feed mats, the information display apparatus comprising:
an obtaining unit that obtains information on a first power feed mat smaller in amount of power feed than other power feed mats among the plurality of power feed mats, the first power feed mat being specified based on power feed information on an amount of power feed to a power feed target, the power feed information being obtained from each of the plurality of power feed mats; and
a display on which information on the first power feed mat is shown.
